(19) United States
(12) Patent Application Publication
(10) Pub. No.: US 2004/0259649 A1
(43) Pub. Date: Dec. 23, 2004

(54) Oil painting set

(76) Inventor: Hayao Mizoguchi, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/413,389

(22) Filed: Apr. 15, 2003

(51) Int. Cl. G09B 11/00

(52) U.S. Cl. 473/84

(57) ABSTRACT

An oil painting set provided with plural sheets of canvas of predetermined size and a drawing board to hold the canvas flat. The drawing board is provided with a board member and a board-shaped cushion material adhered or stuck to the board member as to be layered. Longitudinal and lateral dimensions of the board-shaped cushion material are set to be approximately same as longitudinal and lateral dimensions of the board member respectively. Size of the drawing board is set to be larger than size of the canvas. Clips for detachably holding the canvas are fixed to the drawing board.

### BACKGROUND OF THE INVENTION

1. Field of the Invention

This invention relates to an oil painting set convenient for carrying during a travel.

2. Description of the Related Art

Conventionally, as shown in FIG. 10 and FIG. 11, a sheet of canvas (cloth for painting) 32 for painting a picture in oil paint is set on a wood frame 30 with nails 31. And, the canvas 32 after the painting is set on a frame (not shown in Figures) as it is. And, a painted face, namely, surface of oil paint is exposed to the air to be naturally dried after the painting. And, surface of a palette (not shown in Figures) after the painting is exposed to the air.

However, in the conventional oil painting set, forestal resource is wasted and the oil-painted pictures are difficult to carry for their large volume when plural sheets of painting is made during a travel because the wood frame 30 is required in both of painting and display of the picture, and one wood frame 30 is attached to one sheet of the canvas (cloth for painting) 32.

And, it is difficult to keep the canvas still undried after the painting because the oil paint is not rapidly dried after the picture is finished. That is to say, the painter's body, clothes, sheets, and curtain may be tainted when the painted face (surface of the oil paint) is carelessly handled.

And, the oil paint on the palette have to be removed before every painting because the oil paint on the palette is dried by the next day.

It is therefore an object of the present invention to provide an oil painting set with good portableness in travel with which the wood frame is not required when the picture is painted and displayed, the forestal resource can be remarkably saved.

And, it is another object to provide an oil painting set with which the oil-painted picture is easily kept without tainting things by the oil paint, and the oil-painted picture can be stored in a small space.

Further, it is another object to provide an oil painting set with which the oil paint on the palette is not dried until the next day by shutting out the air.

### BRIEF DESCRIPTION OF THE DRAWINGS

The present invention will be described with reference to the accompanying drawings in which:

FIG. 1A is a top view of an embodiment of the present invention;

FIG. 1B is an explanatory view of the embodiment of the present invention;

FIG. 2A is an enlarged cross-sectional front view of a principal port ion;

FIG. 2B is an enlarged cross-sectional front view of the principal portion;

FIG. 2C is an enlarged cross-sectional front view of the principal portion;

FIG. 3A is a top view;

FIG. 3B is an enlarged cross-sectional front view of the principal portion;

FIG. 4A is a top view;

FIG. 4B is an enlarged cross-sectional front view of the principal portion;

FIG. 5A is a top view;

FIG. 5B is an enlarged cross-sectional front view of the principal portion;

FIG. 6A is a bottom view showing a protection sheet;

FIG. 6B is a perspective view showing a protection sheet;

FIG. 6C is an explanatory view showing a protection sheet;

FIG. 7 is a cross-sectional front view for explanation;

FIG. 8A is a perspective view showing a palette;

FIG. 8B is a side view showing the palette;

FIG. 9 is an extension view showing a cardboard storing body;

FIG. 10 is a perspective view showing a conventional example; and

FIG. 11 is a rear view showing the conventional example.

### DESCRIPTION OF THE PREFERRED EMBODIMENTS

Preferred embodiments of the present invention will now be described with reference to the accompanying drawings.

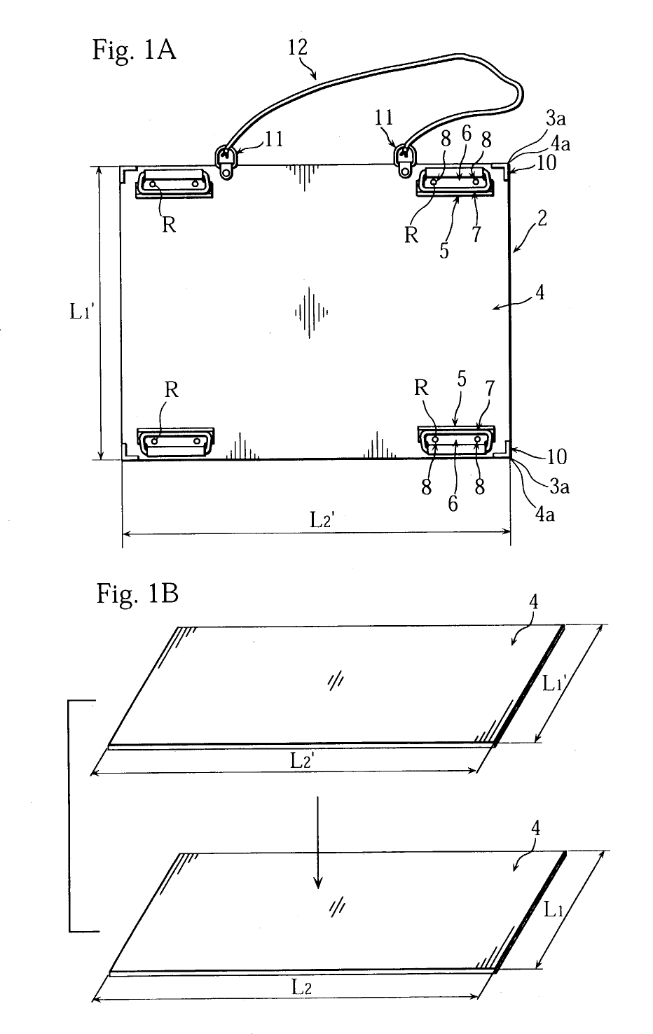

FIGS. 1A through 3B show an embodiment of the present invention. This oil painting set is provided with a sheet of canvas 1 of a predetermined size and a drawing board 2 holding the canvas 1 flat. The drawing board 2 is provided with a board member 3 and a board-shaped cushion material 4 adhered or stuck to the board member 3 to be layered. The board member 3 is composed of cardboard or plywood of which thickness is 2 to 5 mm. The board-shaped cushion material 4 is composed of foamed plastic, for example, polyurethane of which thickness is 2 to 5 mm.

Longitudinal dimension L₁′ and lateral dimension L₂′ of the board-shaped cushion material 4 are set to be the same or approximately same as Longitudinal dimension L₁ and lateral dimension L₂ of the board member 3 respectively. The size of the drawing board 2 is set to be larger than the size of the canvas 1 as a whole in extended state including the peripheral margin. Clips 5 to detachably hold the canvas 1 are attached to the drawing board 2.

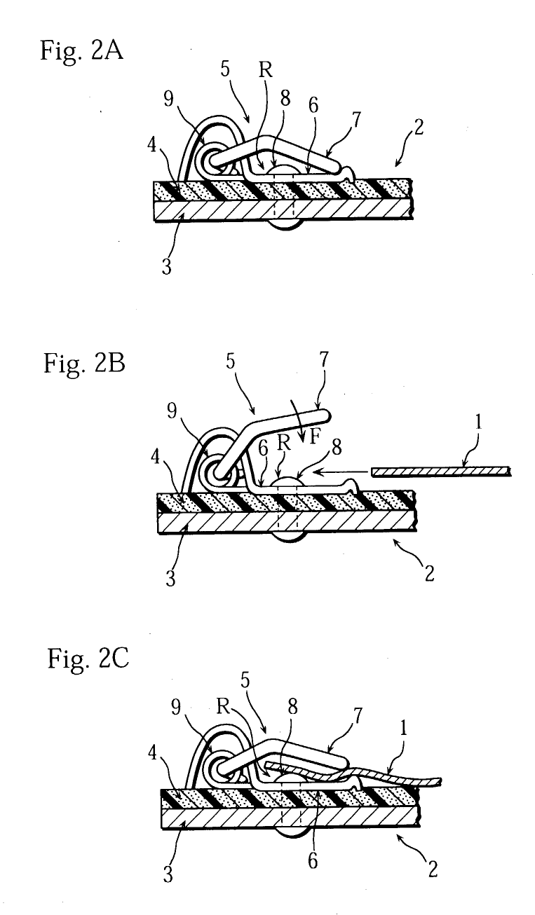

As shown in FIGS. 2A through 2C, the clip 5 is provided with an attachment board 6 and an elastic arm 7 for holding the canvas. The drawing board 2 is provided with a reinforcing means R to reinforce the adherence or stickiness between the board member 3 and the board-shaped cushion material 4. The reinforcing means R is composed of a caulking pin 8 to fix the attachment board 6 to the drawing board 2 and the attachment board 6 press-fit to the front face of the board-shaped cushion material 4. The elastic arm 7 is always pushed elastically in an approaching direction toward the attachment board 6 by an elastic member (a spiral spring, for example).

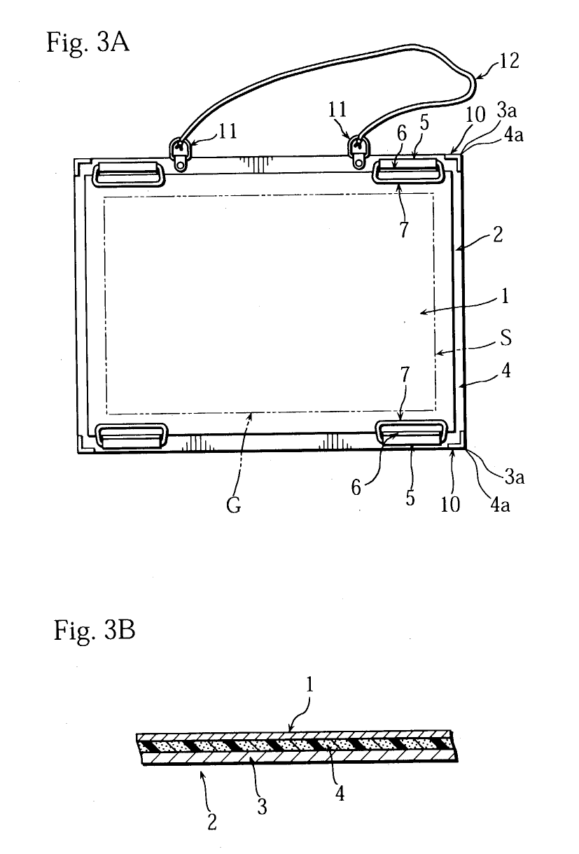

Concretely, FIG. 2A shows a state in which the clip does not hold anything. In this case, elastic force (resilient force) F always works. When the elastic arm 7 is oscillated upward as shown in FIG. 2B, the elastic force (resilient force) F increases. With this condition, the canvas 1 is inserted between the attachment board 6 and the elastic arm 7. FIG. 2C and FIG. 3A show the canvas 1 clipped (held) by four clips 5 each of which is disposed on left and right corners on an upper side and left and right corners on a lower side respectively.

Returning to FIG. 1A, mark 10 represents an L-shaped reinforcing member of metal fixed to a corner portion 3a of the board member 3 and a corner portion 4a of the board-shaped cushion material 4 as to be pinched by caulking. Mark 11 represents an attachment member to attach the string 12. Inclination angle of the drawing board 2 can be stable when the string 12 is worn by a painter on the neck in painting.

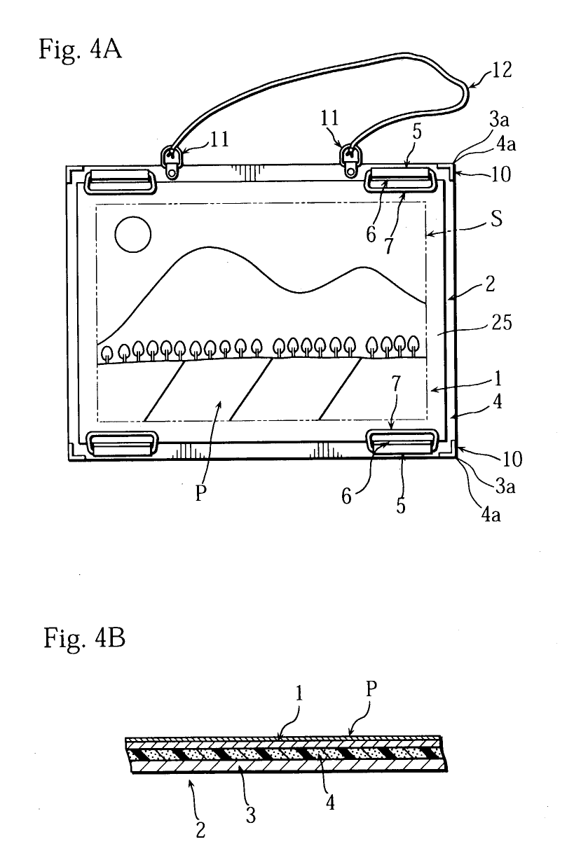

FIG. 4A shows painting state (or a state just after the painting is finished). P represents oil paint. In FIG. 3A and FIG. 4A, a two-dot broken line shows a painting area S corresponding to standard size of the canvas. The clip 5 is on a peripheral margin 25 out of the painting area S. That is to say, the clip 5 holds the peripheral margin 25 out of the area S of the canvas 1.

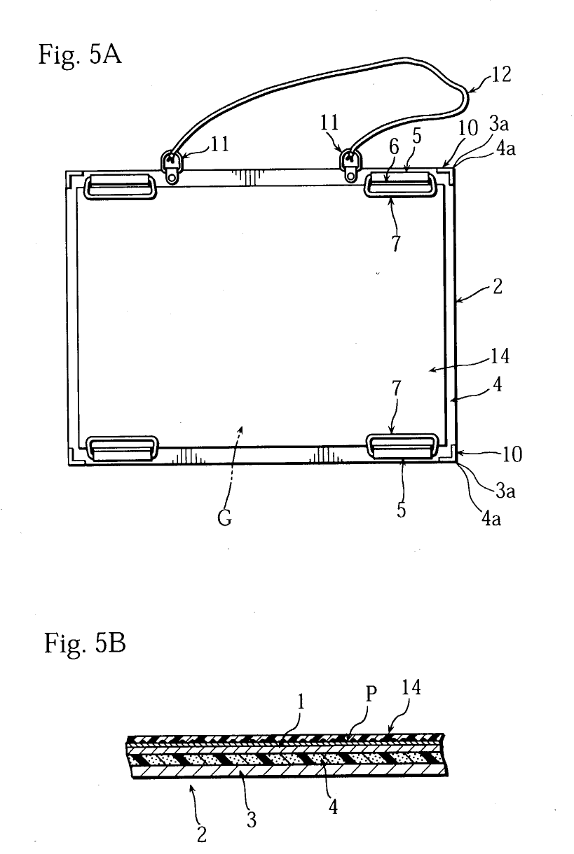

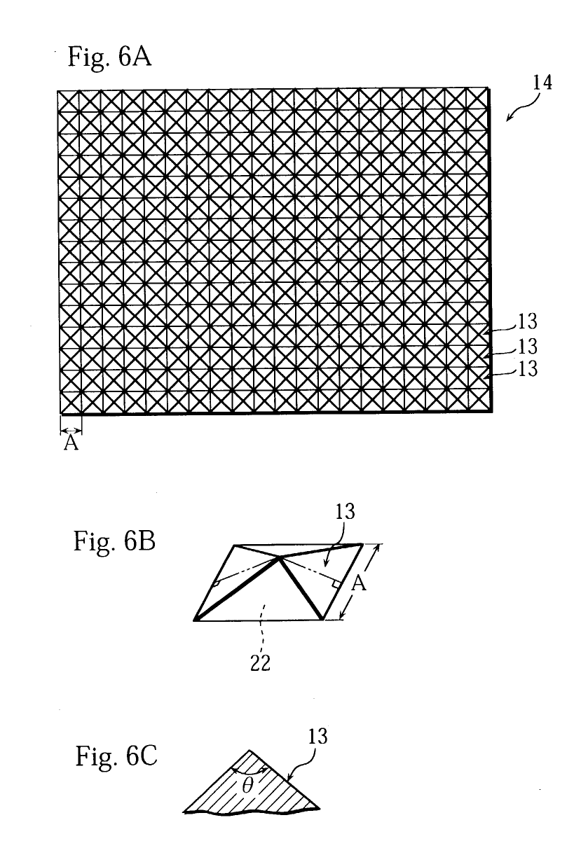

As shown in FIGS. 5A through 6A, the oil painting set is provided with a protection sheet 14 having many small protruding portions 13 to cover the undried oil paint P on the canvas 1 and to prevent the oil paint P from tainting others, namely, person, clothes, curtain, etc. The protection sheet 14 is composed of soft plastic or rubber. The small protruding portion 13 is a pyramid of which bottom face 22 is approximately square, and a length A of one side of the bottom face 22 is set to be 2 mm≦A≦10 mm. If the length A is shorter than 2 mm, production cost of mold (not shown in Figures) is high. When the length A is longer than 10 mm, contact pressure on a peak of the small protruding portion 13 becomes excessive, and concave portions are formed on the surface of the oil paint P by the peak of the small protruding portion 13.

FIG. 6C shows a cross section of the small protruding portion 13 cut as shown by a two-dot broken line in FIG. 6B. Angle θ is set to be 80°≦θ≦120°. When the angle θ is smaller than 80°, contact area with the oil paint P becomes large. And, when the angle θ is larger than 120°, the small protruding portion 13 may stick to the surface of the oil paint P and hinder the departure from the oil paint P.

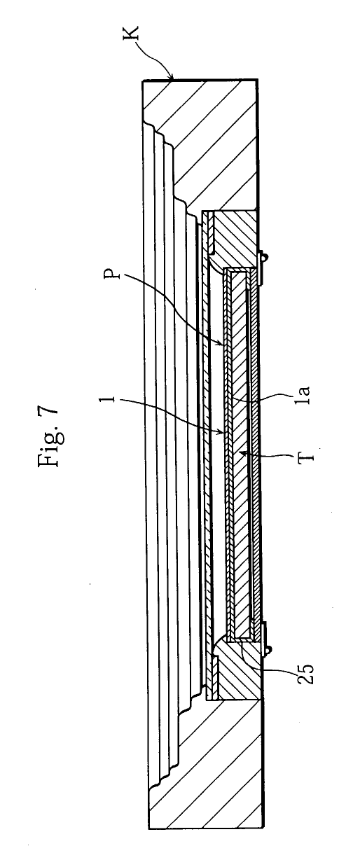

FIG. 7 is a storing state of the canvas 1 in a frame K after the painting. After the oil paint P is dried, a rear board T is made in contact with a reverse side 1a of the canvas 1 to hold the canvas 1 with the frame K and display the painting on the wall (not shown in Figures). The painting area S shown in FIG. 4A approximately corresponds to the size of the rear board T in FIG. 7, and the peripheral margin 25 shown in FIG. 4 is folded as to cover the side ends and periphery of the reverse face of the rear board T and held by the frame K.

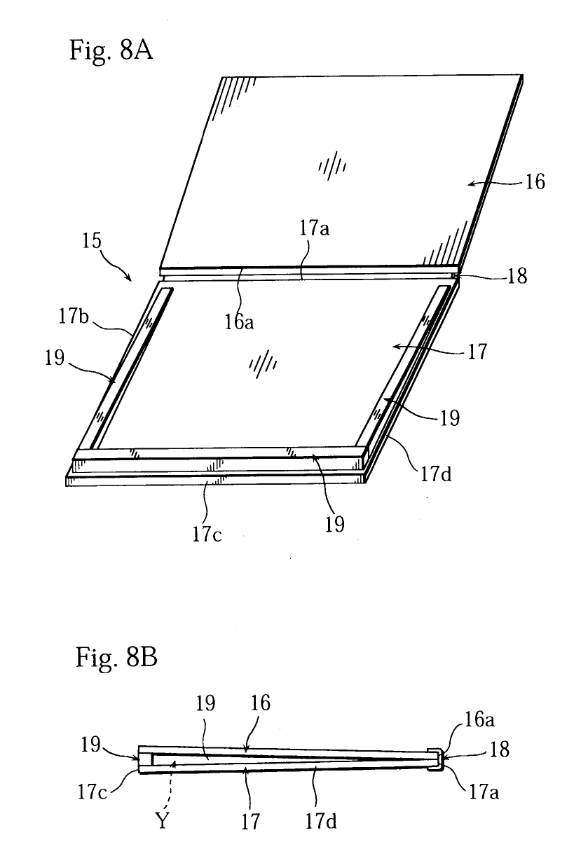

The oil painting set relating to the present invention is preferably provided further with a palette 15 as shown in FIGS. 8A and 8B. The palette 15 has an upper board member 16 rectangular in top view and a lower board member 17 rectangular in top view. One side 16a of the upper board member 16 and one side 17a of the lower board member 17 are connected with a belt body 18 as to oscillate each other. The belt body 18 is, for example, composed of cloth or plastic sheet. The lower board member 17 has protrusions 19 to close an inner space Y tightly when the lower board member 17 and the upper board member 16 made proximate to each other. That is to say, the lower board member 17 has the protrusion 19 on each of positions along three sides 17b, 17c, and 17d. Thickness (height) dimension of the protrusions 19 on the (parallel) sides 17b and 17d gradually decreases backward, namely, toward the belt body 18 side. With this construction, height of the space Y gradually decreases backward.

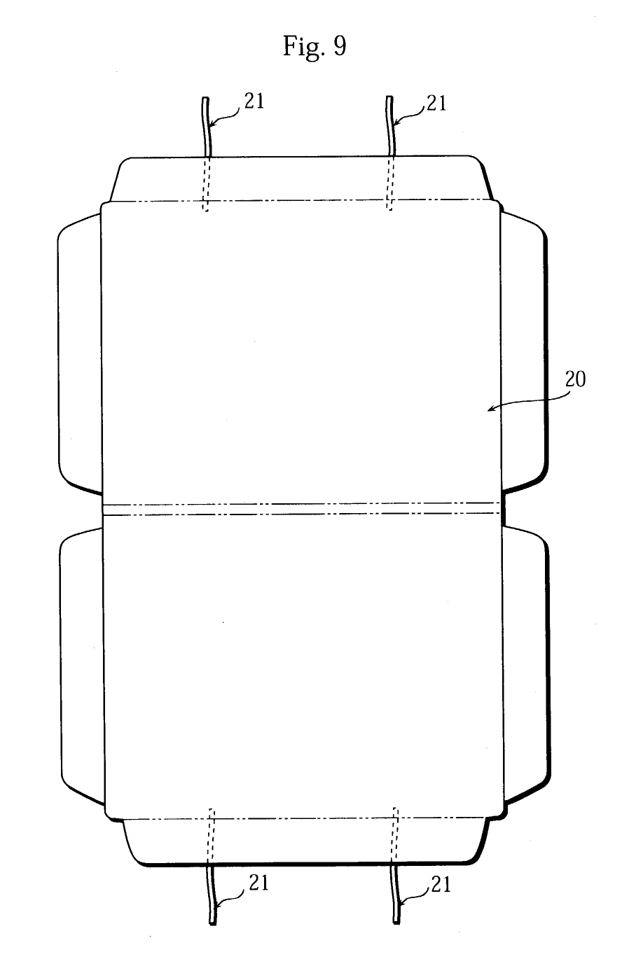

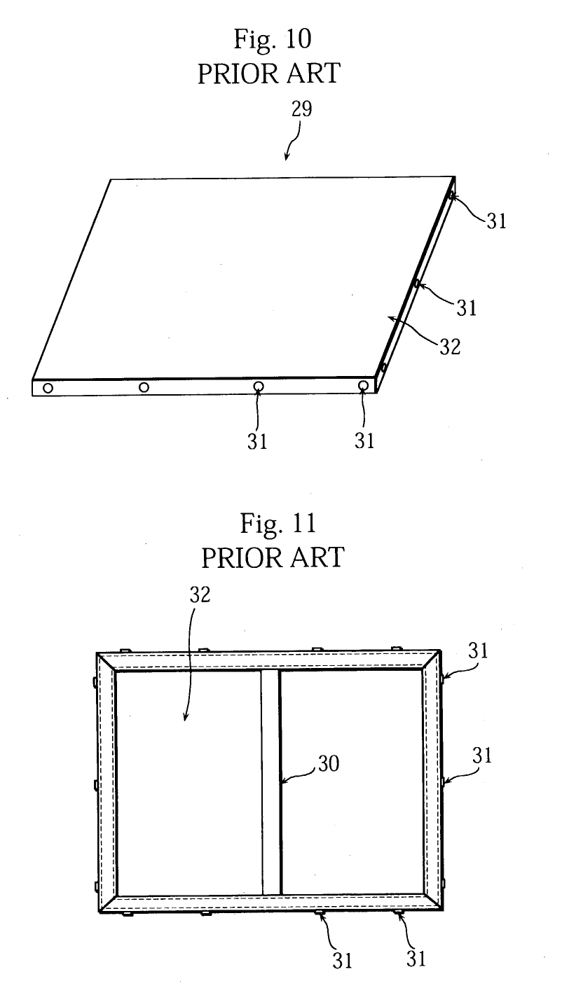

The oil painting set relating to the present invention is preferably provided with a cardboard storing body 20 to store the canvas 1 (refer to FIG. 3A), the drawing board 2, the protection sheet 14 (refer to FIG. 6A), and the palette 15 (refer to FIG. 8A) as shown in FIG. 9. The cardboard storing body 20 has 4 string bodies 21. The above-described plural sheets of canvas 1, the drawing board 2, the protection sheet 14, the palette 15 can be simultaneously stored in the cardboard storing body 20 by folding at two-dot broken lines and knotting the string bodies 21 each other.

It is preferable to place the canvas 1 and the protection sheet 14 layered between the sheets of a sketch book (not shown in Figures) after the painting is finished until held by the frame K (refer to FIG. 7), for example, while the painting is carried during the travel before bringing it back home. It is also preferable to store the canvas 1 and the protection sheet 14, layered and fastened by a stapler to protect the oil paint P, in the cardboard storing body 20. And, the oil painting set of the present invention is provided with plural sheets of canvas 1 in principle. When the number of sheets of the canvas 1 is large, a few protection sheets 14 are preferably provided.

In the present invention, which can be modified in design, for example, the cushion material 4 may be composed of a resin other than foamed urethane (for example, foamed styrene). And, the configuration of the bottom face 22 of the small protruding portion 13 of the protection sheet 14 may be formed into rectangular or rhomboid. The oil painting set relating to the present invention is ordinarily provided with a conventional box to store oil paint, brushes, a palette knife, palette cups, wiper, etc.

According to the oil painting set of the present invention, the volume of the plural sheets of canvas 1 is small, convenient to carry and store, and suitable for travel for painting. And, the board-shaped cushion material 4 facilitates painting on the drawing board 2. The drawing board 2 is excellent in strength because the size of the board member 3 and the size of the board-shaped cushion material 4 are approximately same. The edge of the canvas 1 is not damaged in painting and not hindering the painter's movement, and the canvas 1, keeping beautiful flat state, is easily painted because the drawing board 2 is larger than the canvas 1. The clip 5, attached to the drawing board 2, is easily handled to hold and release the canvas, and not lost. Further, the clip 5, holding the peripheral margin 25 of the canvas 1, does not damage the oil paint P.

And, the corner portion 3a of the board member 3 and the corner portion 4a of the board-shaped cushion material 4 are prevented from being damaged, and the board member 3 and the board-shaped cushion material 4 are prevented from separation.

And, the undried oil paint P is protected as not to contact other things. In other words, the oil paint P before drying is prevented from tainting other things. Therefore, it is quite convenient to paint successively several sheets of painting during the travel.

And, the drying of the remaining oil paint P is delayed for use on the next day during the travel. And, thickness dimension as a whole is minimized for portableness.

Further, the canvas 1, the drawing board 2, etc. are stored compact to be easily carried.

While preferred embodiments of the present invention have been described in this specification, it is to be understood that the invention is illustrative and not restrictive, because various changes are possible within the spirit and indispensable features.

What is claimed is:

1. An oil painting set provided with plural sheets of canvas of predetermined size and a drawing board to hold the canvas flat, wherein the drawing board is provided with a board member and a board-shaped cushion material adhered or stuck to the board member as to be layered, longitudinal dimension and lateral dimension of the board-shaped cushion material are set to be the same or approximately same as longitudinal dimension and lateral dimension of the board member respectively, size of the drawing board is set to be larger than size of the canvas, and a clip to detachably hold the canvas is attached to the drawing board.

2. The oil painting set as set forth in claim 1, wherein the drawing board is provided with a reinforcing means to reinforce adherence or stickiness of the board member and the board-shaped cushion material, the clip is provided with an attachment board and an elastic arm for holding the canvas, and the reinforcing means is composed of the attachment board press-fitted to a front face of the board-shaped cushion material and a caulking pin to fix the attachment board to the drawing board.

3. The oil painting set as set forth in claim 1 or claim 2, wherein the drawing board has an L-shaped reinforcing member fixed to a corner portion of the board member and a corner portion of the board-shaped cushion material as to pinch the corner portions by caulking.

4. The oil painting set as set forth in claim 1, wherein a protection sheet, layered on undried oil paint on the canvas as to cover the oil paint and having many small protruding portions to prevent the oil paint from tainting other things, is provided.

5. The oil painting set as set forth in claim 1 or claim 4, wherein a palette, having an upper board member and a lower board member connected with a belt body as to freely oscillate each other, and a protrusion on the lower board member to make an inner space tightly closed when the lower board member and the upper board member are made proximate to each other, is provided.

6. The oil painting set as set forth in claim 1 or claim 4, wherein a cardboard storing body, to simultaneously store the canvas, the drawing board, and the palette, is provided.
